(19) United States
(12) Patent Application Publication
(10) Pub. No.: US 2008/0203035 A1
(43) Pub. Date: Aug. 28, 2008

(54) WATER TREATMENT METHOD AND WATER TREATMENT APPARATUS

(75) Inventor: Nozomu YASUNAGA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/029,803

(22) Filed: Feb. 12, 2008

(30) Foreign Application Priority Data
Feb. 26, 2007 (JP) 2007-045879

(51) Int. Cl. C02F 1/72; B01D 15/00; C02F 1/78

(52) U.S. Cl. 210/759; 210/198.1

(57) ABSTRACT

To minimize an amount of hydrogen peroxide required for controlling the production of bromic acid in an ozone/hydrogen peroxide treatment. The ozone/hydrogen peroxide treatment is performed at an ozone injection rate by which a predetermined dissolved ozone concentration of the water subjected to an ozone treatment alone can be maintained or at an ozone injection rate by which a specific ratio of absorbance at a specific wavelength of the water to absorbance at a specific wavelength of the water subjected to the ozone treatment alone can be achieved. It is preferable that the injection rate of hydrogen peroxide is 0.01 to 5 times the ozone injection rate on a mass basis.

### FIELD OF THE INVENTION

The present invention relates to a water treatment method and a water treatment apparatus.

### BACKGROUND OF THE INVENTION

Ozone treatment is a main process for advanced water purification treatment. Ozone is effective for sterilization, deodorization, and decoloring of water such as raw water. However, bromide ions (Br⁻) in the water are oxidized to produce bromate ions (BrO₃⁻) which may be carcinogenic. Two routes of production of BrO₃⁻ include: a production route (ozone route) employing Br⁻ and ozone; and a production route (radical route) employing Br⁻ and radical species such as hydroxyl radicals (.OH) which are produced through self-decomposition of ozone. In the ozone route, Br⁻ in the water reacts with ozone to produce hypobromite ions (OBr⁻), and the hypobromite ions are oxidized by ozone to produce BrO₃⁻. In the radical route, BrO₃⁻ is produced by radicals and ozone. It is reported that the BrO₃⁻ is mainly produced through the radical route.

With an amendment of a water quality standard for drinking water of 2004, BrO₃⁻ is regulated to 10 μg/L or less. Further, there is an estimation that the standard for BrO₃⁻ will be strictly regulated to 5 or 2 μg/L or less in the future. In order to respond to the regulations, water purification plants at which an ozone treatment is performed have adopted various measures for controlling production of BrO₃⁻. Specific measures therefor include a constant control of dissolved ozone concentration which is performed by observing the dissolved ozone concentration in the treated water, and feedback controlling an ozone production amount based on the concentration.

Recently, the presence of low-degradable organic substances which are hardly decomposed by ozone such as agricultural chemicals dissolved in the water such as river water, lake water, or the like has become a problem, and decomposition and removal of the low-degradable organic substances require a high ozone injection rate (hereinafter, the injection rate refers to an amount of a substance to be injected into the water per unit amount of the water) The production of BrO₃⁻ increases with the increase of the ozone injection rate, and thus it is difficult to decompose and remove the low-degradable organic substances through an ozone treatment alone and control the production of the BrO₃⁻ at the same time. Thus, an attempt has been made in employing an advanced oxidation treatment technique for decomposing and removing the low-degradable organic substances by using radicals having higher oxidative power than ozone to water purification treatment. Those advanced oxidation treatment techniques are effective for decomposing and removing the low-degradable organic substances which are hardly decomposed by ozone, but may increase the production of BrO₃⁻ by the radicals.

Thus, as a measure for controlling the production of BrO₃⁻ while maintaining a decomposition and removal efficiency for the low-degradable organic substance by the advanced oxidation treatment techniques, there is proposed a method of controlling the production of BrO₃⁻ by increasing a hydrogen peroxide injection rate with respect to the ozone injection rate in an ozone/hydrogen peroxide treatment, which is one of the advanced oxidation treatment techniques (see JP 2005-329312 A, page 7, lines 13 to 28, and FIGS. 6 and 7, for example). However, the method has a problem that the increase in the hydrogen peroxide injection rate controls the production amount of BrO₃⁻ but increases cost of chemicals, i.e., hydrogen peroxide. Further, the method has a defect in that since unreacted hydrogen peroxide remains in the water that has been subjected to the ozone/hydrogen peroxide treatment according to the increase in the hydrogen peroxide injection rate (see Japan Ozone Association, 16th Annual Report, page 23, lines 18 to 21, and FIG. 5, for example), the load of removing hydrogen peroxide in an activated carbon treatment placed in the succeeding stage of the ozone/hydrogen peroxide treatment increases. Further, the method has another defect that since hydrogen peroxide reacts with available chlorine and is consumed, the amount of chlorine required for pasteurization increases when hydrogen peroxide remains in the water that has been subjected to an activated carbon treatment.

Further, in the ozone/hydrogen peroxide treatment, when the hydrogen peroxide injection rate is insufficient with respect to the ozone injection rate, there arises a problem that the production amount of BrO₃⁻ increases, compared with the case where the ozone treatment alone is performed at the same ozone injection rate (see Japan Ozone Association, 16th Annual Report, page 46, lines 21 to 29, and FIG. 3, for example). Therefore, in order to control the production of BrO₃⁻ in the ozone/hydrogen peroxide treatment, it is indispensable to increase the hydrogen peroxide injection rate.

In contrast, a radical reaction advances at the detection limit or lower of the dissolved ozone concentration in the ozone/hydrogen peroxide treatment, there is proposed a control method in a combined method of the ozone treatment and the ozone/hydrogen peroxide treatment (see JP 2001-000984 A, page 3, lines 25 to 33 and FIG. 1, for example). To be specific, according to the dissolved ozone concentration of the water that has been subjected to the ozone treatment in a preceding stage, the ozone injection rate and the hydrogen peroxide injection rate in the ozone/hydrogen peroxide treatment in a succeeding stage are controlled. However, according to this method, since the ozone treatment is performed in the preceding stage, BrO₃⁻ produces in an amount of about several μg/L even if the dissolved ozone concentration is controlled. Thus, the method will not be able to respond to stricter regulations for BrO₃⁻ that are expected in the future. Further, BrO₃⁻, when once produced, cannot be removed by the ozone treatment, the ozone/hydrogen peroxide treatment, or a common activated carbon treatment. The ozone/hydrogen peroxide treatment in the succeeding stage has another defect in that hydrogen peroxide in an excessive amount with respect to the ozone injection rate is required for controlling the production of BrO₃⁻, which increases cost of chemicals, i.e., hydrogen peroxide. As a result, the method has a defect in that the concentration of hydrogen peroxide remaining in the treated water increases, and the load of removing hydrogen peroxide in the activated carbon treatment in the succeeding stage increases.

### SUMMARY OF THE INVENTION

Such a water treatment method and a water treatment apparatus pose a problem that an excessive hydrogen peroxide injection rate with respect to an ozone injection rate is indispensable for controlling the production of BrO₃⁻, which increase cost of chemicals, i.e., hydrogen peroxide.

There arises another problem that since a high-concentration of hydrogen peroxide sometimes remains in the treated water, the load of removing hydrogen peroxide in the activated carbon treatment increases, and moreover, when hydrogen peroxide remains in the water treated with an activated carbon, an amount of chlorine required for sterilization increases.

Further, when the injection rate of hydrogen peroxide is insufficient, the production amount of BrO₃⁻ increases, compared with the case when the ozone treatment alone is performed. Thus, as a measure for avoiding such risks, there arises still another problem that it is required to confirm as to whether the injection of hydrogen peroxide is satisfactorily performed by injecting an excessive amount of hydrogen peroxide with respect to an ozone injection rate or measuring the hydrogen peroxide concentration in the treated water.

Thus, the present invention has been made in order to solve the above-described problems. The present invention aims to provide a water treatment method and a water treatment apparatus that will also be able to respond to stricter regulations for BrO₃⁻ in the future by reducing the hydrogen peroxide injection rate or by reducing the concentration of hydrogen peroxide remaining in the treated water while maintaining the decomposition and removal efficiency for low-degradable organic substances by advanced oxidation treatment.

Therefore, the inventors of the present invention have conducted extensive studies on a water treatment method and a water treatment apparatus for treating the water such as river water or lake water by the combined use of ozone and hydrogen peroxide. As a result, the inventors found that there is a correlation between a dissolved ozone concentration when treating the water with ozone before injecting hydrogen peroxide or a ratio of absorbance of the water into which hydrogen peroxide has not been yet injected to absorbance of water treated with ozone and the production amount of BrO₃⁻ when the ozone/hydrogen peroxide treatment is performed.

Hereinafter, the background to complete the present invention will be described in detail.

It is not limited to Japan that Br is contained in plain water in an amount of several tens μg/L or in an amount as high as several hundreds μg/L. Thus, when the water containing Br⁻ is treated with ozone, ozone and Br⁻ react with each other, whereby OBr⁻ is produced as shown in Equation (1).

O₃+Br⁻→OBr⁻+O₂ (1)

As shown in Equation (2), OBr^{″} is oxidized by ozone, whereby BrO₃⁻ is produced.

2O₃+OBr⁻→BrO₃⁻+20 (2)

Thus, the production amount of BrO₃⁻ can be kept low by maintaining a low dissolved ozone concentration. However even when the dissolved ozone concentration is maintained to be, for example, 0.1 mg/L, BrO₃⁻ is produced in an amount of about several μg/L. Thus, the current BrO₃⁻ regulation value, i.e., 10 μg/L, can be addressed, but stricter regulations for BrO₃⁻ in the future may not be able to be addressed.

In contrast, when the water containing Br⁻ is treated by the ozone/hydrogen peroxide treatment, OH. and Br⁻ react swith each other, whereby OBr⁻ is produced as shown in Equations (3) to (5).

OH.+Br⁻→Br.+OH⁻ (3)

Br.+O₃→OBr.+O₂ (4)

OBr.+OBr.+H₂O→OBr⁻+BrO₂⁻+2H⁺ (5)

At this timing, when hydrogen peroxide exists in a sufficient amount with respect to an amount of ozone injected, OBr⁻ is reduced by hydrogen peroxide to return to Br⁻ as shown in Equation (6).

OBr⁻+H₂O₂→Br⁻+O₂+H₂O (6)

However, when the amount of hydrogen peroxide is insufficient with respect to the amount of ozone injected, the reaction shown in Equation (6) does not advance but, according to the reaction shown in Equation (7), OH. promotes a production reaction of BrO₃⁻, whereby the production amount of BrO₃⁻ increases, compared with the case where the ozone treatment alone is performed.

OBr.+OBr.+2OH.→BrO₃⁻+OBr⁻+2H⁺ (7)

Thus, when hydrogen peroxide sufficiently remains, an amount of BrO₃⁻ of the treated water is around the detection-limit (0.27 μg/L: dionex application report AR02S YS-0075) or BrO₃⁻ cannot be detected. Thus, stricter regulations for BrO₃⁻ in the future can be addressed. However, a large amount of unreacted hydrogen peroxide should remain in treated water. When a sufficient amount of hydrogen peroxide does not remain, the production amount of BrO₃⁻ increases even if the dissolved ozone concentration is not detected, compared with the case where the ozone treatment alone is carried out, and therefore the current regulations for BrO₃⁻ cannot be addressed in some cases.

Therefore, in order to control the production of BrO₃⁻ in the ozone/hydrogen peroxide treatment, hydrogen peroxide needs to be injected in an excessive amount with respect to the ozone injection rate or it is necessary to observe the hydrogen peroxide concentration of the treated water so as to control the injection rate of hydrogen peroxide in such a manner that a sufficient amount of hydrogen peroxide remains. Further, even if the shortage of hydrogen peroxide increases the production amount of BrO₃⁻, dissolved ozone is hardly detected. Therefore, it is impossible to observe the excess or deficiency of hydrogen peroxide based on the dissolved ozone concentration of the treated water.

FIG. 1 shows a correlation between the ozone injection rate when the water having a water temperature of 20° C. is treated with ozone, the dissolved ozone concentration, and the BrO₃⁻ concentration of treated water. The dissolved ozone concentration is not detected until the ozone injection rate reaches a certain value. When the ozone injection rate goes beyond the certain value, the dissolved ozone concentration is detected. As the dissolved ozone concentration increases, the ozone injection rate increases. The ozone injection rate when the dissolved ozone concentration starts to be detected is referred to as a required ozone amount. When the ozone injection rate is made higher than the required ozone amount, whereby 0.1 mg/L of dissolved ozone concentration is detected, the ozone injection rate is 0.9 mg/L and 3 μg/L of BrO₃⁻ was produced.

FIG. 2 shows a correlation between the dissolved ozone concentration and the BrO₃⁻ concentration of treated water, which is obtained by adding hydrogen peroxide in advance in the same water as that of FIG. 1 and treating the water by the ozone/hydrogen peroxide treatment at an ozone injection rate of 0.9 mg/L. In FIG. 2, the axis of abscissa represents a mass ratio of the hydrogen peroxide injection rate to the ozone injection rate (H₂O₂/O₃ ratio) . When the H₂O₂/O₃ ratio is 0, i.e., the ozone treatment alone is carried out, 3 μg/L of BrO₃⁻ is produced. The addition of hydrogen peroxide reduces the production amount of BrO₃⁻. When the H₂O₂/O₃ ratio was 0.5 or higher, the production amount of BrO₃⁻ was decreased to the detection limit or lower. The injection rate of hydrogen peroxide when the H₂O₂/O₃ ratio is 0.5 is represented by 0.9×0.5=0.45 mg/L. Further, when the H₂O₂/O₃ ratio was 0.5, the concentration of the hydrogen peroxide remaining in the treated water was as low as 0.35 mg/L.

FIG. 3 shows a correlation between the decomposition rate of geosmin (moldy material), which is one of the low-degradable organic substances, the BrO₃⁻ concentration, and the H₂O₂/O₃ ratio when the water was treated under the same conditions as shown in FIG. 2. The geosmin decomposition rate sharply improves by the addition of hydrogen peroxide. Moreover, when the H₂O₂/O₃ ratio is 0.5 or higher, the geosmin decomposition rate becomes almost constant. Moreover, the same results are obtained also in other moldy substances other than geosmin, such as 2-MIB, trihalomethane precursors, and agricultural chemicals, and the chromaticity of the substances is the same as that of geosmin.

FIG. 4 shows changes in the dissolved ozone concentration of the treated water with respect to the ozone injection rate when the water having a water temperature of 20° C. is subjected to the ozone treatment alone and the ozone/hydrogen peroxide treatment. In the case of the ozone/hydrogen peroxide treatment, radicals are generated and ozone is consumed by these radicals as shown in Equations (8) and (9). Therefore, the ozone injection rate by which the dissolved ozone can be detected is higher in the ozone/hydrogen peroxide treatment than in the ozone treatment alone, unlike the case of the ozone treatment alone.

H₂O₂⇄HO₂⁻+H⁺ (8)

O₃+HO₂⁻→HO₃.+O₂⁻ (9)

In the ozone/hydrogen peroxide treatment, the dissolved ozone is detected when the amount of hydrogen peroxide reduces to reach a certain value. Further, the production amount of BrO₃⁻ in the ozone/hydrogen peroxide treatment at this timing is larger than that in the ozone treatment alone as described above. Therefore, even if the ozone injection rate is controlled based on the value of the dissolved ozone concentration while performing the ozone/hydrogen peroxide treatment, it is impossible to control the production of BrO₃⁻.

As described above, it is found that, by performing the ozone/hydrogen peroxide treatment at an ozone injection rate by which a low dissolved ozone concentration can be maintained, the production amount of BrO₃⁻ can be sufficiently controlled without adding hydrogen peroxide in an excessive amount with respect to an ozone injection rate while maintaining the decomposition effect of low-degradable organic substances. Moreover, it is confirmed that the above-mentioned phenomenon can be achieved at an ozone injection rate by which the dissolved ozone concentration of the water treated with ozone is 0 to 1 mg/L.

It is also confirmed that the production amount of BrO₃⁻ is larger in a conventional ozone/hydrogen peroxide treatment when hydrogen peroxide is insufficient with respect too zone to be injected, compared with the case where the ozone treatment alone was carried out, but the production amount of BrO₃⁻ can be reduced when the ozone/hydrogen peroxide treatment is carried out at an ozone injection rate by which a low dissolved ozone concentration of the water treated with ozone can be maintained. This is completely different from the fact that a conventional ozone/hydrogen peroxide treatment requires to inject hydrogen peroxide in an excessive amount with respect to ozone to be injected so as to control the production of BrO₃⁻.

FIG. 5 shows changes in absorbance (absorbance (λ=260 nm)) when irradiating, with light having a wavelength of 260 nm, the water subjected to the ozone treatment alone under the same conditions as in FIG. 1. The absorbance (λ=260 nm) is sharply decreased until the ozone injection rate reaches a certain value, and the changes in the absorbance become slow when the ozone injection rate exceeds the certain value. At the same time when the change in the absorbance becomes slow, BrO₃⁻ is detected. It is found that, by utilizing the correlation between the changes in the absorbance (λ=260 nm) and the production of BrO₃⁻, the ozone/hydrogen peroxide treatment which controls the production of BrO₃ similarly as the dissolved ozone concentration can be performed. It was also confirmed that such a phenomenon can be reproduced at a wavelength in the range of 180 to 300 nm.

Based on the above description, in order to control the production of BrO₃⁻ using a small amount of hydrogen peroxide, the inventors of the present invention reached an idea that it is effective that the ozone/hydrogen peroxide treatment is performed at an ozone injection rate by which a predetermined dissolved ozone concentration can be maintained when the water is subjected to the ozone treatment alone or at an ozone injection rate by which a specific ratio of absorbance at a specific wavelength of the water to the absorbance at a specific wavelength of the water which is subjected to the ozone treatment alone can be achieved, and thus the present invention has been accomplished.

That is, the present invention provides a method for treating water by injecting hydrogen peroxide and then ozone into the water, comprising: calculating in advance an ozone injection rate, by which a predetermined dissolved ozone concentration can be achieved, by injecting ozone into part of the water before the injection of hydrogen peroxide; and injecting hydrogen peroxide into the remaining water and then injecting ozone into the remaining water according to the calculated ozone injection rate.

Further, the present invention provides a method for treating water by injecting hydrogen peroxide and then ozone into the water, comprising: irradiating part of the water with light having a wavelength of 180 to 300 nm before the injection of hydrogen peroxide, to measure absorbance; injecting ozone into the part of the water and then irradiating the part of the water with light having the same wavelength as previously used, to measure absorbance; calculating in advance an ozone injection rate by which a ratio of the absorbance of the water after an injection of ozone to the absorbance of the water before an injection of ozone can become a predetermined value; injecting hydrogen peroxide into the remaining water and then injecting ozone into the remaining water according to the calculated ozone injection rate.

Further, the present invention also provides a water treatment apparatus for treating water by injecting hydrogen peroxide and then ozone into the water, comprising: an ozone injection rate calculation system for calculating an ozone injection rate, by which a predetermined dissolved ozone concentration can be achieved, by injecting ozone into part of the water before the injection of hydrogen peroxide; a hydrogen peroxide injection unit for injecting hydrogen peroxide into the remaining water; and an ozone reactor for injecting ozone into the remaining water after the injection of hydrogen peroxide according to the ozone injection rate calculated by the ozone injection rate calculation system, to react the remaining water with ozone.

In addition, the present invention provides a water treatment apparatus for treating water by injecting hydrogen peroxide and then ozone into the water, comprising: an ozone injection rate calculation system for calculating an ozone injection rate by which a ratio of absorbance of the water before an injection of ozone to absorbance of the water after an injection of ozone can become a predetermined value, by irradiating part of the water with light having a wavelength of 180 to 300 nm before the injection of hydrogen peroxide, to measure absorbance, and injecting ozone into the part of the water and irradiating the part of the water with light having the same wavelength as previously used, to measure absorbance; a hydrogen peroxide injection unit for injecting hydrogen peroxide into the remaining water; and an ozone reactor for injecting ozone into the remaining water after the injection of hydrogen peroxide according to the ozone injection rate calculated by the ozone injection rate calculation system, to react the remaining water with ozone.

According to the present invention, the production of bromic acid can be stably controlled using a small amount of hydrogen peroxide while responding to changes in water quality and maintaining the removal ability for removing the low-degradable organic substances such as moldy substances and trihalomethane precursors. Moreover, since the production amount of bromic acid can also be made equal to or lower than the detection limit or made close to the detection limit, stricter regulations for bromic acid in the future can be addressed. Further, the amount of hydrogen peroxide remaining in treated water can be reduced, and the load of an activated carbon treatment in the succeeding stage can be reduced.

### BRIEF DESCRIPTION OF THE DRAWINGS

In the accompanying drawings:

FIG. 1 is a graph showing changes in a dissolved ozone concentration and a production amount of BrO₃⁻ with respect to an ozone injection rate in an ozone treatment;

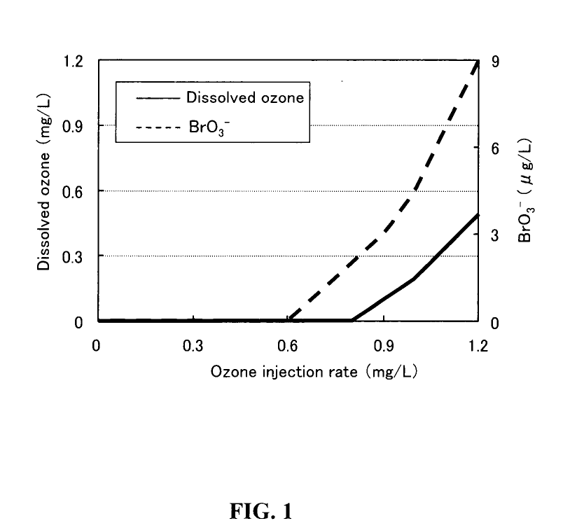

FIG. 2 is a graph showing changes in a dissolved ozone concentration and a production amount of BrO₃⁻ with respect to an H₂O₂/O₃ ratio in the ozone/hydrogen peroxide treatment;

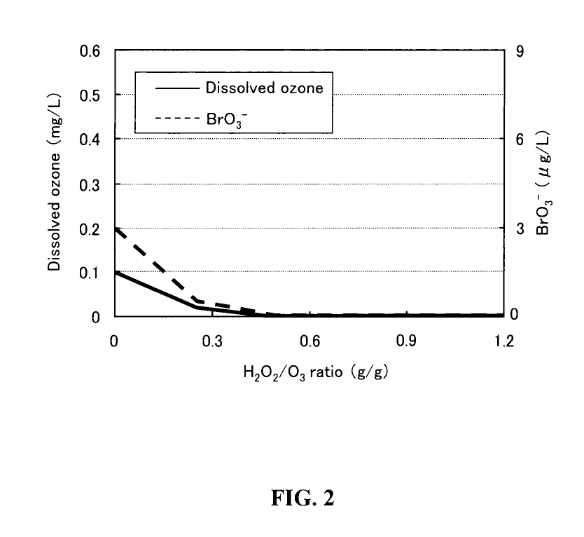

FIG. 3 is a graph showing changes in a geosmin decomposition rate and the production amount of BrO₃⁻ with respect to the H₂O₂/O₃ ratio in the ozone/hydrogen peroxide treatment;

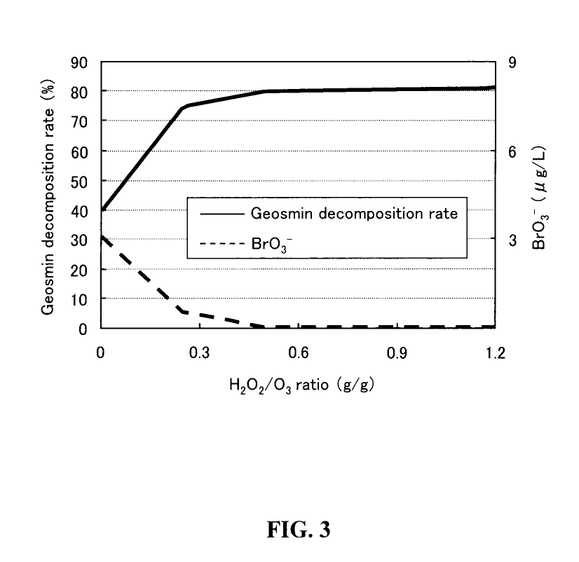

FIG. 4 is a graph showing changes in the dissolved ozone concentration with respect to the ozone injection rate in the ozone treatment and the ozone/hydrogen peroxide treatment;

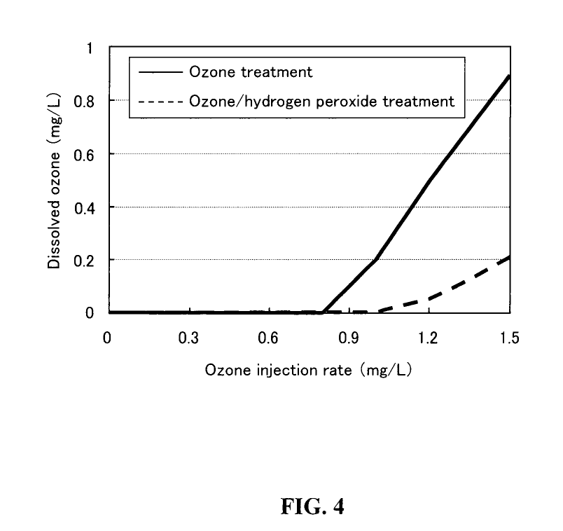

FIG. 5 is a graph showing changes in an absorbance at a wavelength of 260 nm and the production amount of BrO₃⁻ with respect to the ozone injection rate in the ozone treatment;

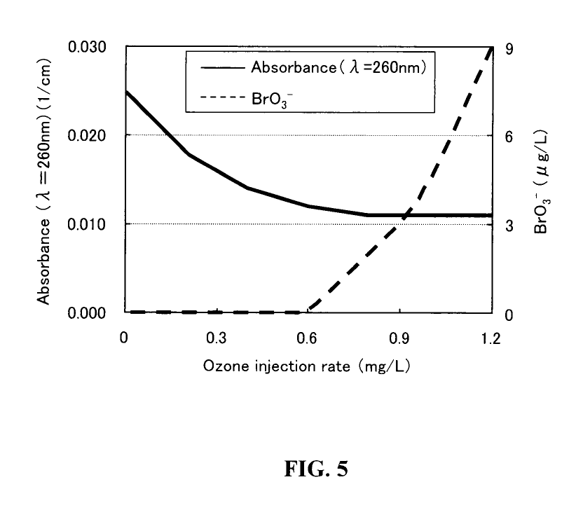

FIG. 6 is a flow diagram for explaining a water treatment apparatus according to Embodiment 1 of the present invention;

FIG. 7 is a graph showing changes in the dissolved ozone concentration with respect to the ozone injection rate in an ozone injection rate calculation-system reactor;

FIG. 8 is a graph showing changes in the dissolved ozone concentration with respect to the ozone injection rate in the ozone injection rate calculation-system reactor at each water temperature;

FIG. 9 is a flow diagram for explaining a water treatment apparatus according to Embodiment 2 of the present invention; and

FIG. 10 is a graph showing changes in an absorbance (wavelength λ=260 nm) with respect to the ozone injection rate in the ozone injection rate calculation-system ozone reactor.

### DESCRIPTION OF THE PREFERRED EMBODIMENTS

Hereinafter, embodiments of the present invention will be described with reference to the attached drawings.

### Embodiment 1

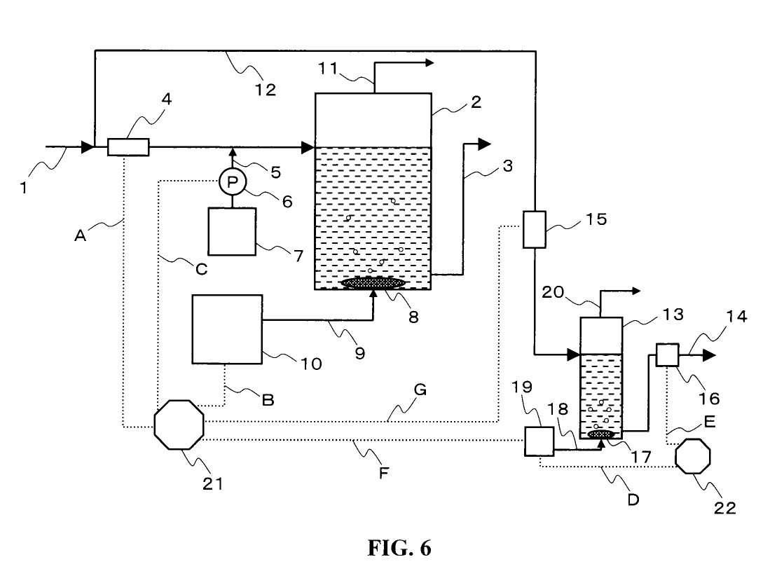

FIG. 6 is a flow diagram for explaining a water treatment apparatus according to Embodiment 1 of the present invention.

In FIG. 6, the water treatment apparatus according to Embodiment 1 includes: an ozone injection rate calculation system which calculates an ozone injection rate in such a manner that a predetermined dissolved ozone concentration is achieved by injecting ozone into part of water before injecting hydrogen peroxide; and a treatment system which treats the water by injecting hydrogen peroxide into the remaining water, and then injecting ozone according to the calculated ozone injection rate.

The treatment system is equipped with a water inlet pipe 1 for water to flow in; a treatment-system ozone reactor 2 which is connected to the downstream of the water inlet pipe 1 and which reacts water with ozone; and a treatment-system treated-water outlet pipe 3 for flowing out water that has been treated in the treatment-system ozone reactor 2. The water inlet pipe 1 is provided with a treatment-system water flow meter 4 for measuring the flow rate of the water. A hydrogen peroxide injection piping 5 is connected to the water inlet pipe 1 between the treatment-system water flowmeter 4 and the treatment-system ozone reactor 2. A hydrogen peroxide storing vessel 7 is connected to the hydrogen peroxide injection piping 5 via a hydrogen peroxide injection pump 6. The hydrogen peroxide injection piping 5, the hydrogen peroxide injection pump 6, and the hydrogen peroxide storing vessel 7 forms a hydrogen peroxide injection unit. A treatment-system diffuser plate 8 is placed inside the treatment-system ozone reactor 2. A treatment-system ozonizer 10 is connected to the treatment-system diffuser plate 8 via the treatment-system ozone gas injection piping 9 in such a manner that ozone gas can be injected into the water in the treatment-system ozone reactor 2. A treatment-system exhausted-ozone gas outlet piping 11 is connected to an upper part of the treatment-system ozone reactor 2.

The ozone injection rate calculation system is connected to the water inlet pipe 1 at the upstream of the treatment-system water flowmeter 4, and is equipped with: a water branch piping 12 for branching part of the water; an ozone injection rate calculation-system ozone reactor 13 which is connected to the downstream of the water branch piping 12 and which reacts branched water with ozone; and an ozone injection rate calculation-system treated water outlet pipe 14 which is connected to the ozone injection rate calculation-system ozone reactor 13 and flows out the water that has been treated in the ozone injection rate calculation-system ozone reactor 13. The water branch piping 12 is provided with an ozone injection rate calculation-system water flowmeter 15 for measuring the flow rate of branched water. The ozone injection rate calculation-system treated water outlet pipe 14 is provided with a dissolved ozone concentration monitor 16 for measuring the dissolved ozone concentration in the water that has been treated in the ozone injection rate calculation-system ozone reactor 13. The ozone injection rate calculation-system ozone reactor 13 is provided with an ozone injection rate calculation-system diffuser plate 17 there inside. An ozone injection rate calculation-system ozonizer 19 is connected to the ozone injection rate calculation-system diffuser plate 17 via an ozone injection rate calculation-system ozone gas injection piping 18. These units are structured so that ozone gas can be injected into the water in the ozone injection rate calculation-system ozone reactor 13. An ozone injection rate calculation-system exhausted ozone gas outlet piping 20 is connected to an upper part of the ozone injection rate calculation-system ozone reactor 13.

The treatment-system water flow meter 4, the treatment-system ozonizer 10, and the hydrogen peroxide injection pump 6 are individually connected to a treatment-system controller 21 via a treatment-system water flow rate signal line A, a treatment-system ozone amount control signal line B, and a hydrogen peroxide amount control signal line C, respectively. The ozone injection rate calculation-system ozonizer 19 and the dissolved ozone concentration monitor 16 are individually connected to an ozone injection rate calculation-system controller 22 via an ozone injection rate calculation-system ozone amount control signal line D and a dissolved ozone concentration signal line E, respectively. The ozone injection rate calculation-system ozonizer 19 is connected to the treatment-system controller 21 via an ozone injection rate calculation-system ozone amount signal line F, and the ozone injection rate calculation-system water flowmeter 15 is also connected to the treatment-system controller 21 via an ozone injection rate calculation-system water flow rate signal line G.

Next, a water treatment method using the water treatment apparatus structured as described above will be described. First, the water including Br⁻ and low-degradable organic substances is introduced into the water inlet pipe 1; part of the water is diverted to the water branch piping 12 and simultaneously hydrogen peroxide is injected into the remaining water from the hydrogen peroxide injection piping 5 after passing through the treatment-system water flowmeter 4. Subsequently, the water into which hydrogen peroxide has been injected is introduced into the treatment-system ozone reactor 2, and simultaneously ozone gas produced in the treatment-system ozonizer 10 is blown into the treatment-system ozone reactor 2 from the treatment-system diffuser plate 8 via the treatment-system ozone gas injection piping 9, and dissolved. Thus, in the treatment system, hydrogen peroxide is consumed and radicals are generated by the combined use of hydrogen peroxide and ozone, and the decomposition reaction of low-degradable organic substances advances due to the radicals. Ozone gas which is not completely dissolved is discharged out of the system via the treatment-system ozone gas outlet piping 11 as exhausted ozone gas. The exhausted ozone gas discharged out of the system is turned into oxygen and rendered harmless by a catalyst or the like, and then is emitted to the atmosphere. The water remains in the treatment-system ozone reactor 2 for a fixed time, and is discharged out of the system from the treatment-system treated-water outlet pipe 3 as treated water in which low-degradable organic substance has been decomposed and removed.

In contrast, the water diverted to the water branch piping 12 is introduced into the ozone injection rate calculation-system ozone reactor 13 via the ozone injection rate calculation-system water flowmeter 15. Simultaneously, ozone gas produced in the ozone injection rate calculation-system ozonizer 19 is blown into the ozone injection rate calculation-system reactor 13 from the ozone injection rate calculation-system diffuser plate 17 via the ozone injection rate calculation-system ozone gas injection piping 18, and is dissolved into the water. By injecting ozone gas as described above, a reaction between ozone and substances contained in the water advances, whereby dissolved ozone is produced. Ozone gas which is not completely dissolved is discharged out of the system via the ozone injection rate calculation-system exhausted ozone gas outlet piping 20 as exhausted ozone gas. The exhausted ozone gas discharged out of the system is turned into oxygen and rendered harmless by a catalyst or the like, and then is emitted to the atmosphere. The water remains in the ozone injection rate calculation-system ozone reactor 13 for a fixed time, and is discharged out of the system from the ozone injection rate calculation-system treated water outlet pipe 14 as treated water in which dissolved ozone is produced.

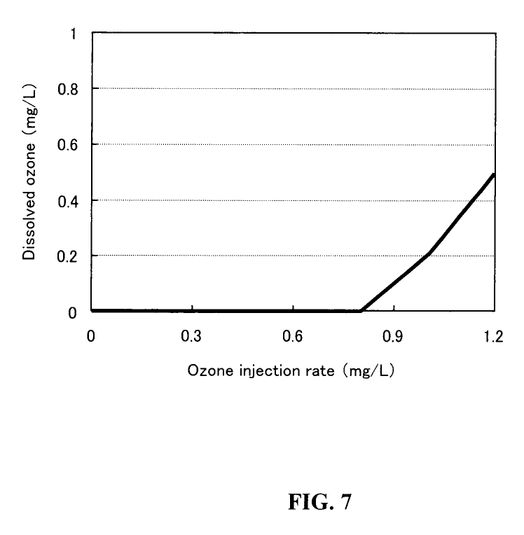

Next, a method of controlling the injection rate of ozone and hydrogen peroxide in the water treatment apparatus according to Embodiment 1 of the present invention will be described in detail. FIG. 7 is a diagram showing changes in the dissolved ozone concentration with respect to the ozone injection rate in the ozone injection rate calculation-system reactor 13. As shown in FIG. 7, dissolved ozone is detected when an ozone injection rate reaches a certain value or becomes higher than the value, and when the ozone injection rate is increased from the certain value, the dissolved ozone concentration increases. The ozone gas concentration or the ozone gas flow rate in the ozone injection rate calculation-system ozonizer 19 is adjusted by the ozone injection rate calculation-system controller 22 in such a manner that a predetermined dissolved ozone concentration is achieved, e.g. the dissolved ozone concentration in the dissolved ozone concentration monitor 16 is adjusted to 0.1 mg/L. To be specific, a signal of a dissolved ozone concentration value of the dissolved ozone concentration monitor 16 is sent to the ozone injection rate calculation-system controller 22 via the dissolved ozone concentration signal line E. When the dissolved ozone concentration is lower than 0.1 mg/L, a command for increasing the ozone gas concentration or the ozone gas flow rate is sent from the ozone injection rate calculation-system controller 22 to the ozone injection rate calculation-system ozonizer 19 via the ozone injection rate calculation-system ozone amount control signal line D. When the dissolved ozone concentration is lower than 0.1 mg/L, a command for reducing the ozone gas concentration or the ozone gas flowrate is sent from the ozone injection rate calculation-system controller 22 to the ozone injection rate calculation-system ozonizer 19 via an ozone injection rate calculation-system ozone amount control signal line D. Thus, the dissolved ozone concentration value of the dissolved ozone concentration monitor 16 is controlled to be 0.1 mg/L. Subsequently, a value of the ozone gas concentration or the ozone gas flow rate of the ozone injection rate calculation-system ozonizer 19 is sent to the treatment-system controller 21 via an ozone injection rate calculation-system ozone amount signal line F. Simultaneously, a value of the ozone injection rate calculation-system water flowmeter 15 is sent to the treatment-system controller 21 via the ozone injection rate calculation-system water flow rate signal line G, and the ozone injection rate in the ozone injection rate calculation-system ozone reactor 13 is calculated in the treatment-system controller 21. Further, a value of the treatment-system water flowmeter 4 is sent to the treatment-system controller 21 via the treatment-system water flow rate signal line A. A value of the ozone gas concentration or the ozone gas flow rate is sent to the treatment-system ozonizer 10 via the treatment-system ozone amount control signal line B in such a manner that the above-calculated ozone injection rate is achieved. Simultaneously, a signal is sent to the hydrogen peroxide injection pump 6 via the hydrogen peroxide amount control signal line C in such a manner that the hydrogen peroxide injection rate corresponds to the ozone injection rate.

The water quality of water changes every moment. However, by controlling the dissolved ozone concentration in such a manner as to maintain a constant concentration by performing the ozone treatment as described above, the ozone/hydrogen peroxide treatment is stabilized and the production of BrO₃⁻ is stably controlled.

Here, it is preferable that a predetermined dissolved ozone concentration be in the range of 0.1 to 1.0 mg/L. When the predetermined dissolved ozone concentration is lower than 0.1 mg/L, the precision of the dissolved ozone concentration monitor 35 may reduce. In contrast, when the predetermined dissolved ozone concentration is higher than 1.0 mg/L, the concentration of hydrogen peroxide remaining in treated water may increase. Thus, such concentrations are not preferable. That is, by adjusting the dissolved ozone concentration to be in the above-mentioned range, the production of bromic acid can be stably controlled using a small amount of hydrogen peroxide while responding to changes in water quality and maintaining the removal efficiency for low-degradable organic substances such as moldy substances and trihalomethane precursors. Moreover, since the production amount of bromic acid is equal to or lower than the detection limit or close to the detection limit, stricter regulations for bromic acid in the future can be addressed. Further, since an amount of hydrogen peroxide remaining in treated water is small, the load of an activated carbon treatment in the succeeding stage can also be reduced.

It is preferable that the injection rate of hydrogen peroxide be 0.01 to 5 times the ozone injection rate on a mass basis. When the hydrogen peroxide injection rate is smaller than 0.01 time the ozone injection rate, the production of BrO₃⁻ may not be sufficiently controlled and the removal efficiency for low-degradable organic substances may be decreased. In contrast, when the hydrogen peroxide injection rate is higher than 5 times the ozone injection rate, the concentration of hydrogen peroxide remaining in treated water may increase. Thus, such concentrations are not preferable. That is, by adjusting the hydrogen peroxide injection rate to be in the above-mentioned range, the production of bromic acid can be stably controlled using a small amount of hydrogen peroxide while responding to changes in water quality and maintaining the removal efficiency for low-degradable organic substances such as moldy substances and trihalomethane precursors. Moreover, since the production amount of bromic acid is equal to or lower than the detection limit or close to the detection limit, stricter regulations for bromic acid in the future can be addressed. Further, since an amount of hydrogen peroxide remaining in treated water is small, the load of an activated carbon treatment in the succeeding stage can also be reduced.

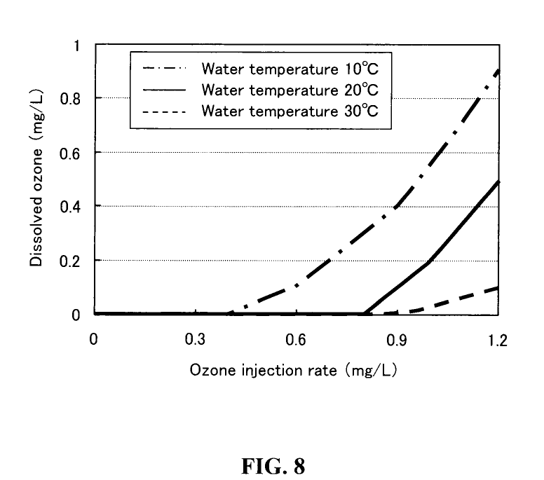

FIG. 8 shows changes in the dissolved ozone concentration of treated water with respect to the ozone injection rate at water temperatures of 10° C., 20° C., and 30° C. when water is treated with ozone. When water temperatures are low, the dissolved ozone concentration increases at the same ozone injection rate, and when water temperatures are high, the dissolved ozone concentration is decreased. Thus, when a predetermined dissolved ozone concentration value in the ozone treatment is kept constant through every year, the ozone injection rate in the ozone/hydrogen peroxide treatment may be insufficient in winter when water temperatures become low. Therefore, it is necessary to change a predetermined dissolved ozone concentration value according to water temperatures. That is, when water temperatures are low, the predetermined dissolved ozone concentration value may be adjusted to be high, and when water temperatures are high, the predetermined dissolved ozone concentration value may be adjusted to be low. For example, when a dissolved ozone concentration is adjusted to 0.4 mg/L when water temperatures are less than 10° C., and a dissolved ozone concentration is adjusted to 0.1 mg/L when water temperatures are 10° C. or higher, a favorable ozone injection rate can be secured. By changing the predetermined dissolved ozone concentration value according to water temperatures, the production of BrO₃⁻ can be controlled still more efficiently while maintaining the removal efficiency for low-degradable organic substances such as moldy substance and trihalomethane precursors.

In the water treatment apparatus according to Embodiment 1 of the present invention, the treatment-system controller 21 and the ozone injection rate calculation-system controller 22 are independently provided. However, when the controllers are individually installed in the treatment-system ozonizer 10 and the ozone injection rate calculation-system ozonizer 19, respectively, the same effect can be acquired.

In the water treatment apparatus according to Embodiment 1 of the present invention, the ozone injection rate calculation-system water flowmeter 15 is provided. However, when the flow rate of the water drawn (diverted) into the ozone injection rate calculation-system ozone reactor 13 is constant and stable, the ozone injection rate calculation-system water flowmeter 15 and the ozone injection rate calculation-system water flow rate signal line G are not required. The flow rate of the water drawn into the ozone injection rate calculation-system ozone reactor 13 is measured beforehand. Thus, the ozone injection rate in the ozone injection rate calculation-system ozone reactor 13 can be calculated from the measured flow rate and a value of the ozone gas concentration or the ozone gas flow rate in the ozone injection rate calculation-system ozonizer 19.

In the water treatment apparatus according to Embodiment 1 of the present invention, part of water is sequentially drawn into the ozone injection rate calculation-system ozone reactor 13. However, a semibatch ozone treatment in which ozone gas is sequentially injected after a certain amount of the water is drawn into the reactor may be employed.

In the water treatment apparatus according to Embodiment 1 of the present invention, when there are two or more parallel treatment systems, the ozone treatment may be performed in one of the systems and the ozone/hydrogen peroxide treatment may be performed in other systems. The ozone/hydrogen peroxide treatment may be performed at an ozone injection rate by which the dissolved ozone concentration in the system in which the ozone treatment is performed, can become the above-mentioned calculated value.

In the water treatment apparatus according to Embodiment 1 of the present invention, the ozone/hydrogen peroxide treatment is performed at an ozone injection rate in the ozone injection rate calculation-system ozone reactor 13 in which the ozone treatment is performed. However, the ozone/hydrogen peroxide treatment may be performed based on an ozone consumption calculated from the difference between an injected ozone gas concentration and an exhausted ozone gas concentration of the ozone injection rate calculation-system ozone reactor 13 in which the ozone treatment is performed, i.e., an amount of ozone absorbed per liter of the water.

In the water treatment apparatus according to Embodiment 1 of the present invention, a plurality of treatment-system ozone reactors 2 in which the ozone/hydrogen peroxide treatment may be provided in-series.

In the water treatment apparatus according to Embodiment 1 of the present invention, an ozone injection rate may be calculated utilizing stored data which are obtained by controlling the dissolved ozone concentration by the ozone treatment without using the ozone injection rate calculation-system ozone reactor 13.

In the water treatment apparatus according to Embodiment 1 of the present invention, an activated carbon treatment vessel may be provided in a succeeding stage of the treatment-system ozone reactor 2, thereby removing hydrogen peroxide remaining in treated water.

According to Embodiment 1 of the present invention, by performing the ozone/hydrogen peroxide treatment according to a value of the dissolved ozone concentration when the water is treated with ozone, the production of BrO₃⁻ can be stably controlled using a small amount of hydrogen peroxide while responding to changes in water quality and maintaining the removal efficiency for low-degradable organic substances such as moldy substances and trihalomethane precursors, and moreover, since the production amount of BrO₃⁻ is equal to or lower than the detection limit or close to the detection limit, stricter regulations for bromic acid in the future can be addressed. Further, since an amount of hydrogen peroxide remaining in treated water is small, the load of an activated carbon treatment in the succeeding stage can also be reduced.

### Embodiment 2

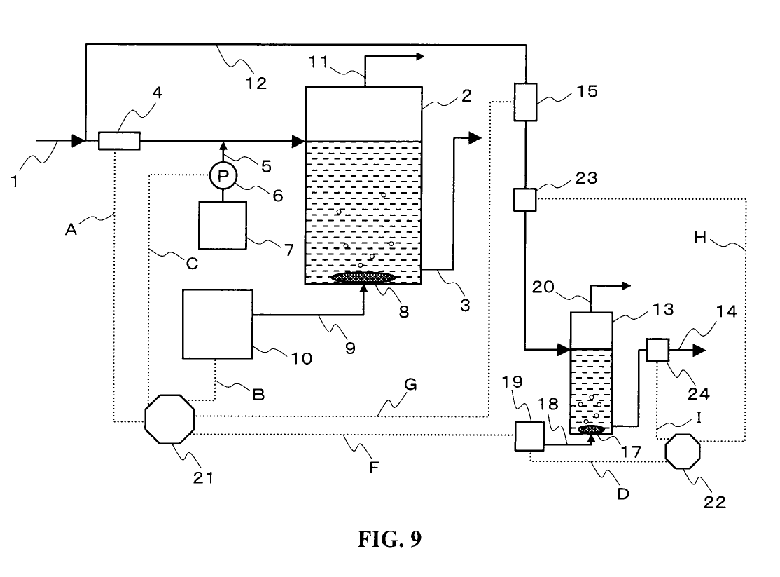

FIG. 9 is a flow diagram for explaining a water treatment apparatus according to Embodiment 2 of the present invention.

A water treatment apparatus according to Embodiment 2 in FIG. 9 is structured and operated in the same manner as the water treatment apparatus according to Embodiment 1 except that a water absorbance meter 23, a treated water absorbance meter 24, a water absorbance signal line H, and a treated water absorbance signal line I are provided in place of the dissolved ozone concentration monitor 16 and the dissolved ozone concentration signal line E. Thus, the description thereof is omitted.

Different structures of the apparatus according to Embodiment 2 from that according to Embodiment 1 will be described. The water absorbance meter 23 is located at the water branch piping 12 between the ozone injection rate calculation-system water flowmeter 15 and the ozone injection rate calculation-system ozone reactor 13. The treated water absorbance meter 24 is located at the ozone injection rate calculation-system treated water outlet pipe 14. The water absorbance meter 23 and the treated water absorbance meter 24 are individually connected to the ozone injection rate calculation-system controller 22 via the water absorbance signal line H and via the treated water absorbance signal line I, respectively. The water absorbance meter 23 may be located at the upstream of the ozone injection rate calculation-system water flowmeter 15 and may be located at the water inlet pipe 1. There is no limitation on the water absorbance meter 23 and the treated water absorbance meter 24 that are used in the water treatment apparatus according to Embodiment 2 of the present invention insofar as they can irradiate the water or treated water with light having a specific wavelength and can measure the absorbance. A water treatment method using the water treatment apparatus structured as mentioned above is the same as that of Embodiment 1, and therefore, the description thereof is omitted.

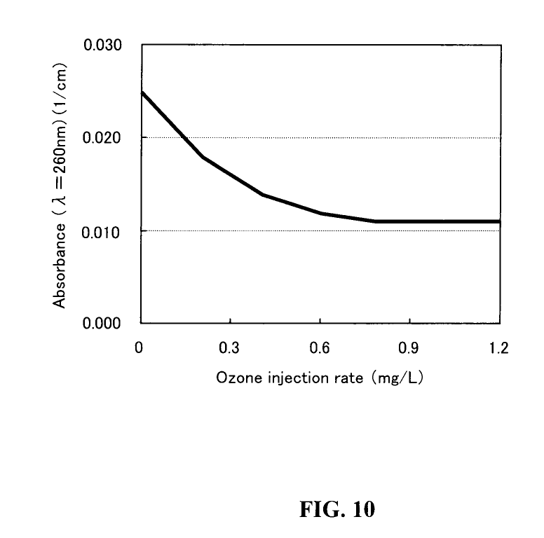

Next, a method of controlling an injection rate of ozone and hydrogen peroxide in the water treatment apparatus according to Embodiment 2 of the present invention will be described in detail. FIG. 10 shows changes in the absorbance (wavelength λ=260 nm) with respect to the ozone injection rate in the ozone injection rate calculation-system ozone reactor 13. As shown in FIG. 10, when the ozone injection rate is increased, an absorbance value is decreased, and the ozone injection rate becomes constant when reaching or goes beyond a certain value. The ozone gas concentration or the ozone gas flow rate of the ozone injection rate calculation-system ozonizer 19 is adjusted by the ozone injection rate calculation-system controller 22 in such a manner that a ratio of absorbance of water into which ozone has been injected to absorbance of water into which ozone has not yet been injected (X=the absorbance of water after the injection of ozone to the absorbance of water before the injection of ozone) is as calculated in advance, e.g., X=0.5 at a wavelength λ=260 mm. To be specific, the absorbance of the water absorbance meter 23 is sent to the ozone injection rate calculation-system controller 22 via the water absorbance signal line H, and simultaneously, the absorbance of the treated water absorbance meter 24 is sent to the ozone injection rate calculation-system controller 22 via the treated water absorbance signal line I. An X value is calculated in the ozone injection rate calculation-system controller 22. In the case of X>0.5, a command for increasing the ozone gas concentration or the ozone gas flow rate is sent from the ozone injection rate calculation-system controller 22 to the ozone injection rate calculation-system ozonizer 19 via the ozone injection rate calculation-system ozone amount control signal line D. In the case of X<0.5, a command for reducing the ozone gas concentration or the ozone gas flow rate is sent from the ozone injection rate calculation-system controller 22 to the ozone injection rate calculation-system ozonizer 19 via the ozone injection rate calculation-system ozone amount control signal line D, whereby the X value is controlled to be 0.5. Since the control method following to the above process is the same as that of Embodiment 1, and therefore, the description thereof is omitted.

The water quality of treated water changes every moment. However, by controlling the ratio X of absorbance of the water into which ozone has been injected to absorbance of the water into which ozone has not yet been injected in such a manner as to maintain a constant ratio X by performing the ozone treatment as described above, the ozone/hydrogen peroxide treatment is stabilized and the production of BrO₃⁻ is stably controlled.

Here, it is preferable that the predetermined X value be in the range of 0.2 to 0.8. When the X value is smaller than 0.2, the ozone injection rate may be insufficient, and in contrast, when the X value is larger than 0.8, the ozone injection rate may be excessively high, and thus such X values are not preferable. That is, by adjusting the X value to be in the above-mentioned range, the production of bromic acid can be stably controlled using a small amount of hydrogen peroxide while responding to changes in water quality and maintaining the removal efficiency for low-degradable organic substances such as moldy substances and trihalomethane precursors. Moreover, since the production amount of bromic acid is equal to or lower than the detection limit or close to the detection limit, stricter regulations for bromic acid in the future can be addressed. Further, since an amount of hydrogen peroxide remaining in treated water is small, the load of an activated carbon treatment in the succeeding stage can also be reduced.

It is preferable that the injection rate of hydrogen peroxide be 0.01 to 5 times the ozone injection rate on a mass basis. When the hydrogen peroxide injection rate is smaller than 0.01 time the ozone injection rate, the production of BrO₃⁻ may not be sufficiently controlled and the removal efficiency for low-degradable organic substances may be decreased. In contrast, when the hydrogen peroxide injection rate is higher than 5 times the ozone injection rate, the concentration of hydrogen peroxide remaining in treated water may be increased. Thus, such concentrations are not preferable. That is, by adjusting the hydrogen peroxide injection rate to be in the above-mentioned range, the production of bromic acid can be stably controlled using a small amount of hydrogen peroxide while responding to changes in water quality and maintaining the removal efficiency for low-degradable organic substances such as moldy substances and trihalomethane precursors. Moreover, since the production amount of bromic acid is equal to or lower than the detection limit or close to the detection limit, stricter regulations for bromic acid in the future can be addressed. Further, since an amount of hydrogen peroxide remaining in treated water is small, the load of an activated carbon treatment in the succeeding stage can also be reduced.

When water temperatures are high, the absorbance is high, and when water temperatures are low, the absorbance is low. However, since the X value is substantially calculated based on the ozone injection rate, a stable treatment can be achieved by controlling the X value to maintain a constant value throughout a year.

In the water treatment apparatus according to Embodiment 2 of the present invention, the treatment-system controller 21 and the ozone injection rate calculation-system controller 22 are independently provided. However, when the controllers are individually installed in the treatment-system ozonizer 10 and the ozone injection rate calculation-system ozonizer 19, respectively, the same effect can be acquired.

In the water treatment apparatus according to Embodiment 2 of the present invention, the ozone injection rate calculation-system water flowmeter 15 is provided. However, when the flow rate of water drawn (diverted) into the ozone injection rate calculation-system ozone reactor 13 is constant and stable, the ozone injection rate calculation-system water flowmeter 15 and the ozone injection rate calculation-system water flow rate signal line G are not required. The flow rate of the water drawn into the ozone injection rate calculation-system ozone reactor 13 is measured beforehand. Thus, the ozone injection rate in the ozone injection rate calculation-system ozone reactor 13 can be calculated from the measured flow rate and a value of the ozone gas concentration or the ozone gas flow rate in the ozone injection rate calculation-system ozonizer 19.

In the water treatment apparatus according to Embodiment 2 of the present invention, part of water is sequentially drawn into the ozone injection rate calculation-system ozone reactor 13. However, a semibatch ozone treatment in which ozone gas is sequentially injected after a certain amount of the water is drawn into the reactor may be employed.

In the water treatment apparatus according to Embodiment 2 of the present invention, when there are two or more parallel treatment systems, the ozone treatment may be performed in one of the systems and the ozone/hydrogen peroxide treatment may be performed in other systems. The ozone/hydrogen peroxide treatment may be performed at an ozone injection rate by which the X value in the system in which the ozone treatment is performed, can become the above-mentioned calculated value.

In the water treatment apparatus according to Embodiment 2 of the present invention, the ozone/hydrogen peroxide treatment is performed at an ozone injection rate in the ozone injection rate calculation-system ozone reactor 13 in which the ozone treatment is performed. However, the ozone/hydrogen peroxide treatment may be performed based on an ozone consumption calculated from the difference between an injected ozone gas concentration and an exhausted ozone gas concentration of the ozone injection rate calculation-system ozone reactor 13 in which the ozone treatment is performed, i.e., an amount of ozone absorbed per liter of water.

In the water treatment apparatus according to Embodiment 2 of the present invention, a plurality of treatment-system ozone reactors 2 in which the ozone/hydrogen peroxide treatment may be provided in-series.

In the water treatment apparatus according to Embodiment 2 of the present invention, an ozone injection rate may be calculated utilizing stored data which are obtained by controlling the X value by the ozone treatment without using the ozone injection rate calculation-system ozone reactor 13.

In the water treatment apparatus according to Embodiment 2 of the present invention, an activated carbon treatment vessel may be provided in a succeeding stage of the treatment-system ozone reactor 2, thereby removing hydrogen peroxide remaining in treated water.

According to Embodiment 2 of the present invention, by performing the ozone/hydrogen peroxide treatment according to the ratio of absorbance of water into which ozone has been injected to absorbance of water into which ozone has not yet been injected, the production of bromic acid can be stably controlled using a small amount of hydrogen peroxide while responding to changes in water quality and maintaining the removal efficiency for the low-degradable organic substances such as moldy substances and trihalomethane precursors. Moreover, since the production amount of bromic acid can also be lowered than the detection limit or made close to the detection limit, stricter regulations for bromic acid in the future can be addressed. Further, the amount of hydrogen peroxide remaining in treated water can be reduced, and the load of an activated carbon treatment in the succeeding stage can be reduced. Further, an expensive dissolved ozone concentration meter is unnecessary.

What is claimed is:

1. A method for treating water by injecting hydrogen peroxide and then ozone into the water, comprising:
calculating in advance an ozone injection rate, by which a predetermined dissolved ozone concentration can be achieved, by injecting ozone into part of the water before the injection of hydrogen peroxide; and
injecting hydrogen peroxide into the remaining water and then injecting ozone into the remaining water according to the calculated ozone injection rate.

2. A method for treating water by injecting hydrogen peroxide and then ozone into the water, comprising:
irradiating part of the water with light having a wavelength of 180 to 300 nm before the injection of hydrogen peroxide, to measure absorbance;
injecting ozone into the part of the water and then irradiating the part of the water with light having the same wavelength as previously used, to measure absorbance;
calculating in advance an ozone injection rate by which a ratio of the absorbance of the water after an injection of ozone to the absorbance of the water before an injection of ozone can become a predetermined value;
injecting hydrogen peroxide into the remaining water and then injecting ozone into the remaining water according to the calculated ozone injection rate.

3. A water treatment method according to claim 1 or 2, wherein the injection rate of the hydrogen peroxide is 0.01 to 5 times the ozone injection rate on a mass basis.

4. A water treatment method according to claim 1, wherein the dissolved ozone concentration is adjusted to 0.1 to 1.0 mg/L.

5. A water treatment method according to claim 2, wherein the ratio of the absorbance of the water after an injection of ozone to the absorbance of the water before an injection of ozone is adjusted to 0.02 to 0.8.

6. A water treatment apparatus for treating water by injecting hydrogen peroxide and then ozone into the water, comprising:
an ozone injection rate calculation system for calculating an ozone injection rate, by which a predetermined dissolved ozone concentration can be achieved, by injecting ozone into part of the water before the injection of hydrogen peroxide;
a hydrogen peroxide injection unit for injecting hydrogen peroxide into the remaining water; and
an ozone reactor for injecting ozone into the remaining water after the injection of hydrogen peroxide according to the ozone injection rate calculated by the ozone injection rate calculation system, to react the remaining water with ozone.

7. A water treatment apparatus for treating water by injecting hydrogen peroxide and then ozone into water, comprising:
an ozone injection rate calculation system for calculating an ozone injection rate by which a ratio of absorbance of the water before an injection of ozone to absorbance of the water after an injection of ozone can become a predetermined value, by irradiating part of the water with light having a wavelength of 180 to 300 nm before the injection of hydrogen peroxide, to measure absorbance, and injecting ozone into the part of the water and irradiating the part of the water with light having the same wavelength as previously used, to measure absorbance;
a hydrogen peroxide injection unit for injecting hydrogen peroxide into the remaining water; and
an ozone reactor for injecting ozone into the remaining water after the injection of hydrogen peroxide according to the ozone injection rate calculated by the ozone injection rate calculation system, to react the remaining water with ozone.
